(19) United States
(12) Patent Application Publication
(10) Pub. No.: US 2013/0013425 A1
(43) Pub. Date: Jan. 10, 2013

(54) METHOD AND SYSTEM FOR AUTOMATICALLY GENERATING ADVERTISING CREATIVES

(75) Inventors: Darren Spehr, Seattle, WA (US); Matthew Berk, Seattle, WA (US)

(73) Assignee: Marchex, Inc., Seattle, WA (US)

(21) Appl. No.: 13/176,709

(22) Filed: Jul. 5, 2011

(51) Int. Cl. G06Q 30/00

(52) U.S. Cl. 705/14.72

(57) ABSTRACT

A system and method to automatically generate display text for advertisements. The generated creatives may be distributed in text, banner, email, or other advertising formats through online advertising distribution networks. To generate creatives, the system utilizes a record of the grammatical structure (or “grammar”) of creatives and combinations of two or more words (“N-grams”) to populate each grammar. To generate grammars of creatives, the system analyzes a large set of creatives that have previously been used in advertisements to populate grammar and N-gram datasets. Once the grammar and N-gram datasets are populated with a sufficient number of grammars and N-grams, the system is able to generate new creatives for advertisements. The system populates the selected grammars using N-grams that are obtained from the N-gram dataset in order to form new creatives.

### BACKGROUND

Online advertising is a form of promotion that uses the Internet and World Wide Web for the purpose of delivering marketing messages to attract customers. Online advertisements may be presented to customers in a variety of different formats, including, for example, keyword advertisements, online banners, interstitial advertisements, pre- and post-roll advertisements, and email advertisements. Online advertising may also be distributed to consumers through a variety of different channels, including search engine results pages (e.g., search result pages provided by Google or Microsoft), social networking sites (e.g., Facebook), online classifieds sites (e.g., Craigslist), and content sites (e.g., The New York Times, Yahoo!). The wide number of formats and multitude of channels that an advertiser may use has meant that advertisers have been forced to generate more and more display text for the advertisements in order to provide text that is suitable for the particular format and channel. The text that is generated for an advertisement is typically referred to as the “advertisement creative,” or simply “creative.”

All advertisers like to maximize the effectiveness of the money that they spend on advertising. Thus, advertisers try to produce creatives that result in the highest benefits (e.g., most profit) to the advertiser. An advertiser attempting to sell a product or service may spend significant resources for advertisement space and for paying marketing professionals to design a creative to use in an advertising campaign. Production of an advertisement creative can be a costly and labor-intensive process and, while some creatives can be highly effective at producing significant profit, others can result in little, or even lost, profit.

One of the challenges of producing a large number of new creatives is advertisers have historically relied upon a largely manual workflow to produce creatives. Relying on manual labor to create new creatives has a number of shortcomings. For example, one shortcoming is that the subjective experience and/or personal preference of the individual generating a creative can be reflected in the creatives. This can result in an over-reliance on an individual's personal patterns in generating new creatives and a lack of keyword and/or textual diversity in the new creative. Another shortcoming is that individuals may become tired and less efficient at producing creatives if forced to repetitively generate creatives. Still another shortcoming is that manual production limits the ability of the individual to see trends or strategies that lead to more effective creatives across a large dataset. Present methods to generate advertisements fall short of solving these challenges in a number of respects.

### BRIEF DESCRIPTION OF THE DRAWINGS

FIG. 1 is a block diagram illustrating an exemplary environment in which a system that automatically generates advertising creatives can operate.

FIG. 2 is a block diagram of the advertising creative generation system and its constituent modules that are used in generating creatives.

FIG. 3 is a flow diagram of a process that is executed by the system to prepare historic creatives for analysis.

FIGS. 4A-C are a flow diagram and accompanying examples of a process that is executed by the system to analyze historic creatives, including a representative tokenizing of a historic creative and segmenting of a creative into bi-grams using a sliding window.

FIG. 5 is a representative set of N-gram records that are generated by the system.

FIG. 6A is a flow diagram of a process for dynamically generating creatives for advertisements.

FIG. 6B is a flow diagram of a process for selecting N-grams to construct phrases in a creative.

### DETAILED DESCRIPTION

A system and method to automatically generate display text for advertisements (hereinafter referred to as the “advertisement creative” or “creative”) is disclosed herein. The generated creatives may be distributed in text, banner, email, or other advertising formats through online advertising distribution networks, including, but not limited to distribution networks like Google AdWords, DoubleClick, Bing Search Ads, and Yahoo! Search. By automatically generating creatives for advertisements, the system greatly reduces the amount of manual resources that are required to generate and launch advertising campaigns through one or more distribution networks. Moreover, the system improves the performance of creatives by basing the automatically-generated creatives at least in part on creatives that have been successful or frequently used in generating advertising traffic from consumers in the past.

In order to generate creatives, the system utilizes a record of the grammatical structure (or “grammar”) of creatives and combinations of two or more words (“N-grams”) to populate each grammar. To generate grammars of creatives, the system analyzes a large set of creatives that have previously been used in advertisements. The larger the set of historic creatives that are analyzed, the greater the variety of grammars that are typically generated. Historic creatives from an extended period (e.g., months or years) are therefore typically analyzed by the system. As will be described in additional detail herein, the historic creatives are analyzed to generate a record of the grammatical structure of the creatives. Moreover, historic creatives are analyzed to generate a set of N-grams from each of the creatives. The grammars and N-gram datasets that are generated from the analysis of historic creatives are stored by the system in one or more datasets for subsequent use in the generation of new creatives.

Once the grammar and N-gram datasets are populated with a sufficient number of grammars and N-grams, the system is able to generate new creatives for advertisements. The system receives a request for new advertisements from advertisers or other parties interested in placing advertisements. One or more grammars are selected by the system from the business category that is associated with the advertising request. The system then populates the selected grammars using N-grams that are obtained from the N-gram dataset in order to form new creatives. Although there may be some variance in the quality of the creatives generated using the disclosed automated method, the advertising text generated by the disclosed system and method significantly reduces the total time necessary to generate creatives for distribution over advertising networks.

Various embodiments of the invention will now be described. The following description provides specific details for a thorough understanding and an enabling description of these embodiments. One skilled in the art will understand, however, that the invention may be practiced without many of these details. Additionally, some well-known structures or functions may not be shown or described in detail, so as to avoid unnecessarily obscuring the relevant description of the various embodiments. The terminology used in the description presented below is intended to be interpreted in its broadest reasonable manner, even though it is being used in conjunction with a detailed description of certain specific embodiments of the invention.

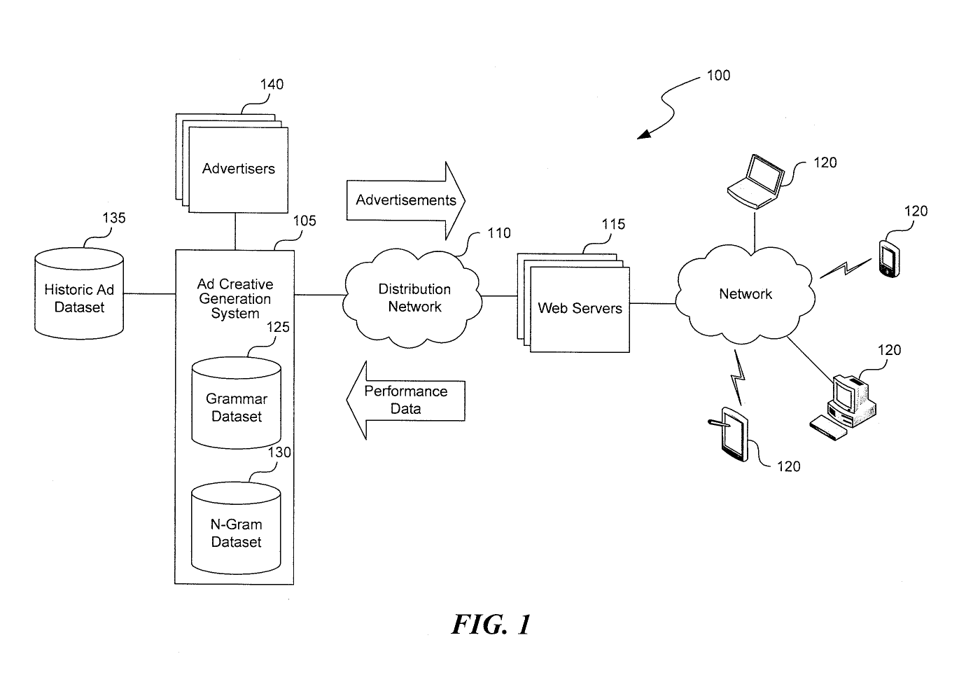

FIG. 1 is a block diagram illustrating an exemplary environment 100 in which an advertising creative generation system 105 can operate. The creative generation system 105 automatically generates creatives for distribution in text, banner, email, or other advertising formats through online distribution networks 110. Creatives are generated based on a grammar dataset 125 and N-gram dataset 130 that is accessed by the system 105. As will be described in additional detail herein, the grammar dataset 125 contains a record of the grammatical structure (or “grammar”) of creatives. The N-gram dataset 130 contains combinations of two or more words (“N-grams”) that are used to populate grammars that are selected from the grammar dataset. Although any length N-gram may be used, in a preferred configuration the system relies upon bi-grams (i.e., N-grams of length two) when constructing creatives.

The grammar dataset 125 and N-gram dataset 130 are generated by analyzing historic advertising creatives that are contained in a historic ad dataset 135. The historic ad dataset 135 is large enough (i.e., contains a sufficient number of entries) to provide a representative sample of creatives used across a variety of different business categories. For example, the dataset may be compiled from a record of advertisements that were distributed by distributor networks (e.g., Google, Microsoft) over a period of several months or years. Each creative that is analyzed may include one or more pieces of associated metadata, such as a business or individual name associated with the creative (e.g., “State Farm Insurance,” “Costco”), a category of the goods or service being offered by the business or individual (e.g., insurance, furniture, electronics, car repair), a location of the business or individual (e.g., a city and state of the business), a period of time that the creative was distributed through an advertising network (e.g., January-February, 2009), and a geographic scope of distribution of the creative (e.g., Washington and Oregon). Moreover, the associated metadata may also include performance data reflecting the effectiveness of the creative (e.g., a measurement of the click-through rate, conversion rate, etc., of the creative). One skilled in the art will appreciate that a greater or lesser amount of metadata may be associated with the creative than the listed metadata. As will be described in additional detail herein, the historic creatives are analyzed to generate a record of the grammars of the creatives. The grammars are stored in a grammar dataset 125. Moreover, the historic creatives are analyzed to generate a set of N-grams from each of the creatives, and the N-grams are stored in the N-gram dataset 130. The system 105 may generate the grammar and N-gram dataset itself, or the system may access grammar and N-gram datasets that are generated and provided by other parties.

Once the grammar dataset 125 and N-gram dataset 130 are populated with a sufficient number of grammars and N-grams, the system 105 is able to generate new creatives. The creative generation system 105 receives one or more requests for new advertisements from advertisers 140 or other parties interested in placing advertisements. An advertisement request will typically include a business category for which the creatives are to be constructed. For example, the advertiser may want to advertise a car repair service, outdoor clothing that it manufactures, an upcoming sale that it is offering, or the advantages of a particular political cause that is espouses. If the request does not specify a particular business category, the system may estimate the business category based on the identity of the goods or services being advertised or may choose a default business category. The advertiser request will typically include other advertising campaign parameters, such as a budget, a time during which the campaign should run, and various rules that specify the conditions under which the advertisements with generated creatives are to be distributed. An operator of the system 105 specifies to the system the number of grammars that the creatives to be built across and a maximum number of creatives per grammar. Alternatively, the system may automatically determine a reasonable number of creatives and grammars depending on the desired number of advertisement that are to be distributed through the distribution network 110. The system 105 builds creatives for advertisements by selecting a grammar from the grammar dataset 125 and populating the grammar using appropriate N-grams from the N-gram dataset 130. The system continues until the desired number of creatives for the particular advertiser has been generated.

After generation, the creatives and the associated campaign parameters are provided by the system 105 to one or more of the online advertising distribution networks 110. Advertising distributors which directly or indirectly distribute advertisements include, but are not limited to, advertising distribution networks like Google AdWords, DoubleClick, Bing Search Ads, and Yahoo! Search. The distributed advertisements are typically syndicated through many websites that are operated on web servers 115. In some embodiments, the system 105 may also distribute advertisements directly to web servers 115 (i.e., the system may operate as the distribution network itself).

Consumers 120 access the websites containing the distributed advertisements using mobile or fixed, wired or wireless, computing devices such as personal computers, laptop computers, tablet computers, mobile phones, mobile gaming devices, or the like. At the websites, the consumers are exposed to one or more advertisements that contain the creative text. The consumer reaction to presented advertisements is often monitored by the advertising distributors. For example, the distributors may monitor the click-through rate of particular advertisements, or the conversion rate of consumers that select an advertisement. The performance data may be provided to the creative generation system 105 to improve the generation of future creatives by taking the performance of the current creatives into consideration when constructing additional grammars or N-grams.

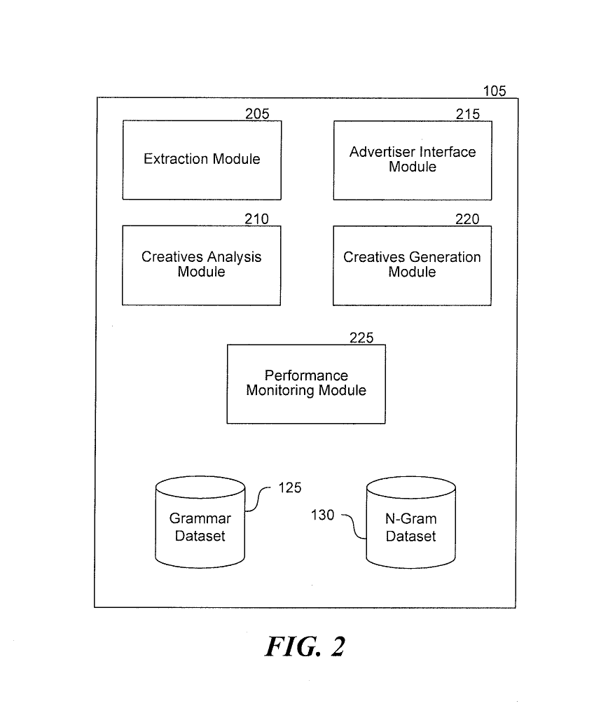

FIG. 2 is a block diagram of the creative generation system 105 and illustrates modules used in generating creatives for advertisements. Those skilled in the art will appreciate that the system 105 may be implemented on any computing system or device. Suitable computing systems or devices include personal computers, server computers, multiprocessor systems, microprocessor-based systems, minicomputers, mainframe computers, distributed computing environments that include any of the foregoing, and the like. Such computing systems or devices may include one or more processors that execute software to perform the functions described herein. Processors include programmable general-purpose or special-purpose microprocessors, programmable controllers, application specific integrated circuits (ASICs), programmable logic devices (PLDs), or the like, or a combination of such devices. Software may be stored in memory, such as random access memory (RAM), read-only memory (ROM), flash memory, or the like, or a combination of such components. Software may also be stored in one or more storage devices, such as magnetic or optical based disks, flash memory devices, or any other type of non-volatile storage medium for storing data. Software may include one or more program modules which include routines, programs, objects, components, data structures, and so on that perform particular tasks or implement particular abstract data types. The functionality of the program modules may be combined or distributed across multiple computing systems or devices as desired in various embodiments, and may be implemented in hardware, a combination of hardware and software, software, or software in execution.

The system 105 includes an extraction module 205, a creatives analysis module 210, an advertiser interface module 215, a creatives generation module 220, and a performance monitoring module 225 to implement the functionality disclosed herein. The various modules access, as necessary, the historic ad dataset 135, the grammar dataset 125, and the N-gram dataset 130. The operation of each module will be described in turn.

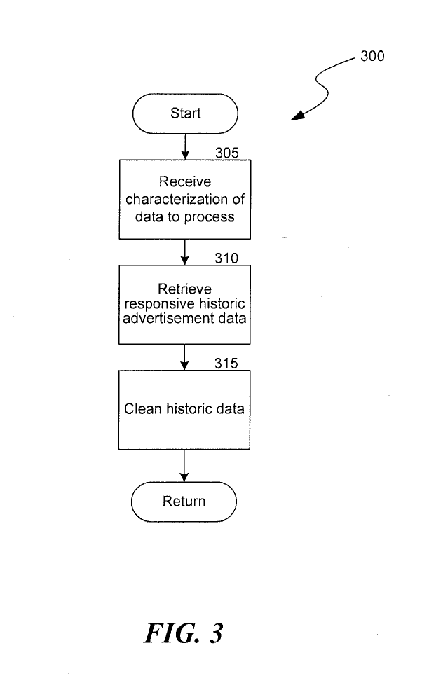

The extraction module 205 selects and prepares historic advertisement data that is stored in the historic ad dataset 135 for processing. FIG. 3 is a flow diagram of a process 300 that is executed by the extraction module 205 to prepare the previously-used creatives for analysis. At a block 305, the system receives an indication from an operator as to the scope of the historic data that is to be analyzed. The operator may choose to limit the data that is analyzed based on any of the metadata that is associated with stored creatives. For example, the operator may choose to analyze historic creatives that are only associated with a particular company (e.g., Costco, Target) or are associated with a particular category of product or service (e.g., real estate services, retail electronics, clothing boutiques, legal or medical professional services). The operator may also apply date range restrictions, geographic limitations, thresholds of desired advertisement effectiveness, etc., to the data that is to be retrieved. At a block 310, the system retrieves data from the historic ad dataset 135 that is responsive to the received scope of analysis. A representative record that is retrieved from the historic ad dataset may resemble the following:
{“id”:“22_{—}14277”,“name”:“Caldwell Banker Towne Realty”,“desc”:“Ready to Find Your Dream Home? Our Agents Can Help. Call or Visit Us.”,“cat”:1022,“city”:“Montromery”,“state”:“AL”}
   Where “id” is a unique identifier associated with the record in the dataset, “name” is the company that is associated with the advertisement, “desc” is the creative that was used in the advertisement, “cat” is a number representing the category of the product or service being advertised (in the depicted example, real estate services), and “city” and “state” reflect the location of the business. At a block 315, the system may clean the retrieved data. For example, the system may remove erroneous characters or may modify the data to ensure consistent formatting across all retrieved data. The processing by the extraction module 205 is then complete.

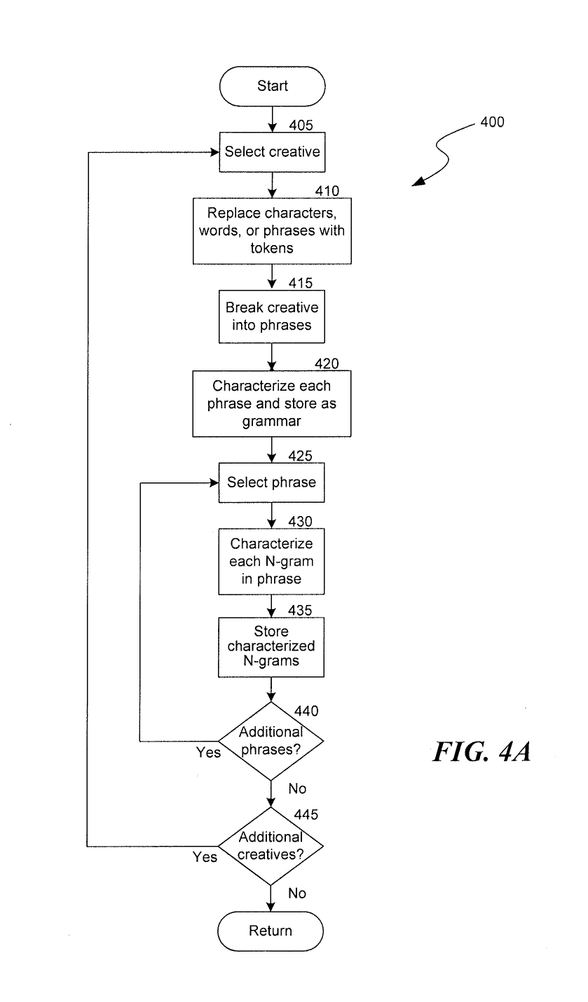

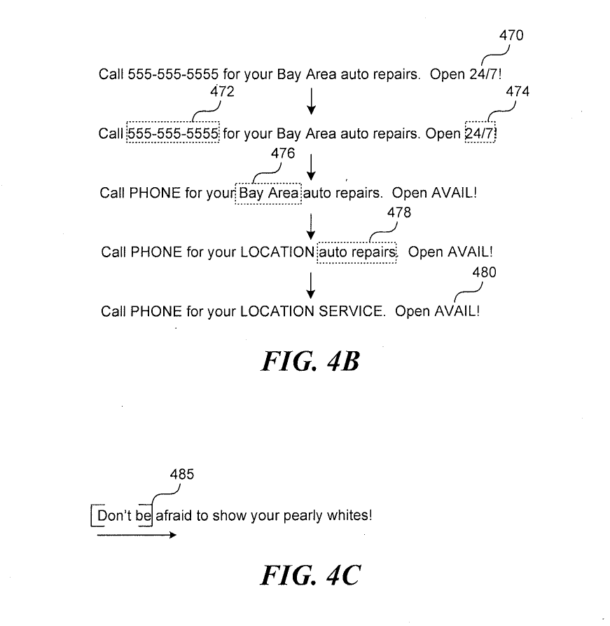

Returning to FIG. 2, once the desired historic data has been retrieved and prepared by the extraction module 205, it may be processed by the creatives analysis module 210. The creatives analysis module 210 analyzes the historic creatives to generate grammars and N-grams. FIG. 4A is a flow diagram of a process 400 that is executed by the creatives analysis module 210 to analyze previously-used creatives. At a block 405, the system 105 selects a creative to process from the retrieved data. At a block 410, the system parses the text of the creative to remove characters, words, or phrases that are limited in scope and replace them with tokens that reflect the generic concept of the removed characters, words, or phrases. The process of tokenizing may include one or more of the following replacements:
Words or phrases that represent places or geographies may be replaced with a relevant token that represents the removed word or phrase. For example, if the city name “Seattle” is included in a creative, the name can be replaced with a token indicating that the removed word is a city. The system identifies words or phrases that represent places or geographies by comparing the text of the creative with an index of relevant places or geographies.
Numbers that represent dates, phone numbers, and zip codes may be replaced with a relevant token that indicates the type of removed number. For example, the number “206-555-1212” may be replaced with a token indicating that the removed number was a phone number. The system identifies dates, phone numbers, and zip codes by searching for particular number strings that meet defined formatting patterns and indexed values (e.g., an index that contains the current area codes and zip codes of the United States or other jurisdiction).
Numbers that represent monetary values or discounts may be replaced with a relevant token that indicates the type of removed number. For example, the phrase “$10” may be replaced with a token indicating that the removed number was a dollar value. The system identifies monetary values by searching for particular strings that meet defined formatting patterns (e.g., “$”, “£”) or phrasing (e.g., “10% off”).
Numbers that represent opening times, closing times, or hours of operation may be replaced with a relevant token that indicates the removed time. For example, the phrase “Open at 8 am every day!” may have a token inserted in place of the opening time. The system identifies numbers representing times by searching for particular strings that meet defined formatting patterns (e.g., “am” “pm” “24/7”) or phrasing (e.g., “open at ______”).
Certain words or phrases that represent particular keywords may be replaced with a relevant token. For example, a brand name (e.g., “Sony”) or product model number (e.g., “DROID X” phone) may be replaced with a token reflecting the removed keyword. The system identifies keywords by comparing the text of the creative with an index of relevant words or phrases.

FIG. 4B depicts a representative tokenizing of a historic creative 470 that is performed by the creatives analysis module 210. During a first review of the creative 470, the system identified a phone number 472 (“555-555-5555”) and an hours of operation 474 (“24/7”) that is contained in the creative. The system therefore replaces the phone number with a PHONE token and the time with an AVAIL token. During a second review of the creative 470, the system identifies a location 476 (“Bay Area”) that is contained in the creative. The system therefore replaces the location with a LOCATION token. Finally, during a third review of the creative 470 the system identifies a service 478 (“auto repairs”) that is contained in the creative, and replaces the service with a SERVICE token. The resulting creative 780 contains four tokens which makes the creative more adaptable to a broader variety of situations when subsequently deconstructed by the creatives analysis module. While three reviews are depicted in FIG. 4B for pedagogical purposes, it will be appreciated that the analysis and tokenizing of the creative may take place in a single step. Moreover, although four tokens are depicted in FIG. 4B, it will be appreciated that a creative may have a greater or lesser number of tokens, and in some cases will have no tokens.

Returning to FIG. 4A, after the creative has been tokenized, processing continues to a block 415. At block 415, the system parses the creative to identify punctuation or other syntactic structures that describe the internal organization of the creative. For example, the creative may be parsed to identify punctuation marks (e.g., “.” “?” “!”) that divide the creative into different phrases. The following Table 1 provides some representative creatives and the number of phrases that are determined by the system as a result of an analysis of the punctuation in the creative:

TABLE 1

| Example Creative | Number of Phrases |
|---|---|
| We are your number one supplier of | 1 phrase |
| toggles. | |
| Call us today! We have great widgets for | 2 phrases |
| sale. | |
| Have roofing issues? Call us at PHONE! | 3 phrases |
| We get the job done right. | |
| We fix cars, trucks, and RVs. | 1 phrase |

After identifying the number of phrases in a creative, at a block 420 the system analyzes each phrase in the creative and assigns an appropriate characterization of the phrase. The characterization describes the structure of the phrase, and is used when generating the grammar and subsequently building new creatives. To characterize each phrase, the system 105 assigns one or more codes to each phrase in accordance with the following Table 2:

TABLE 2

| Phrase Type | Code |
|---|---|
| Question | Q |
| Statement | S |
| Exclamation | E |
| List Item | I |
| Phone | P |
| Location | L |
| Offer | O |
| Founded | F |
| Keyword | K |
| Contact Action | C |

The phrase types that are provided in Table 2 are merely representative, and a greater or lesser number of phrase types may be used depending on the complexity of the grammars that are being created. The system identifies which phrase type to assign to a phrase based on keywords, punctuation, or other structures that are contained in the phrase. For example, a phrase is characterized as a question if it ends in a question mark, and a phrase is characterized as a list item if it contains one or more commas indicative of a list. Once each phrase in a creative has been characterized, the resulting characterization is stored as the grammar for that creative. Using the example creatives from Table 1 and the codes in Table 2, the following grammars in Table 3 are therefore formed:

TABLE 3

| Example Creative | Phrase Type | Grammar |
|---|---|---|
| We are your number one | 1 statement phrase | 1:S |
| supplier of toggles. | | |
| Call us today! We have | 1 exclamation with contact action | 1:EC |
| great widgets for sale. | 1 statement | 2:S |
| Have roofing issues? | 1 question | 1:Q |
| Call us at PHONE! | 1 exclamation with contact action | 2:ECP |
| We get the job done | and phone | 3:S |
| right. | 1 statement | |
| We fix cars, trucks, and | 1 statement with list items | 1:SI |
| RVs. | | |

The grammar of each creative is the aggregate characterization of all phrases that are in the creative. The resulting grammars are stored by the system in the grammar dataset 125. In some embodiments, each grammar is stored with (i) a unique identifier that identifies the grammar; (ii) a count of the number of phrases in the grammar; and (iii) an indication of the product or service category that the grammar is associated with. Specialty grammars may therefore be constructed for each industry segment, with the grammars proving to be uniquely suited for selling products or services in that industry segment. The following Table 4 includes the fields of a representative record that is stored in the grammar dataset 125:

TABLE 4

| Creative Flag | ID | Category ID | Phrase Count | Grammar |
|---|---|---|---|---|
| C | 2 | 3490 | 2 | 1:EC 2:S |

Where the creative flag identifies that the record is a creative, the ID is a unique identifier associated with the grammar, the category ID identifies the industry segment of the advertised goods or services, the phrase count indicates the number of phrases in the creative, and the grammar is the grammar determined by the system.

After constructing the grammar for each creative, the system analyzes each phrase in the creative to identify N-grams and construct an N-gram representation of each phrase. At a block 425, the system therefore selects one of the phrases of the creative. Using a sliding window of length two or more, the words of the creative are segmented into interlinked groups. FIG. 4C depicts a sliding window 485 of length 2 that is used to segment the depicted creative into bi-grams. In the depicted example, the first bi-gram is “don't be,” the second bi-gram is “be afraid,” the third bi-gram is “afraid to,” etc. As the sliding window 485 traverses the creative, at a block 430 the system characterizes each N-gram segment. Each N-gram is identified by its location in the phrase, including whether the N-gram is a starting, middle, or ending N-gram. Each N-gram is also identified by the next N-gram that appears in the creative. For list items (items in a phrase separated by commas), it is also determined whether a comma precedes and/or follows the N-gram. At a block 435, the system stores a characterization of the N-grams that are contained in the phrase. Table 5 is a representative data table in which the system stores the N-gram representation of an analyzed phrase:

TABLE 5

| | | | | | | |
|---|---|---|---|---|---|---|
| Loca- | | Phrase | Lead | Next N- | Previous | |
| tion | Text | Type | Term | Gram | N-Gram | Comma |

Phrase: Don't be afraid to show your pearly whites!

| | | | | | |
|---|---|---|---|---|---|
| Start | don't be | E | don't | afraid to | |
| Middle | be | E | be | to show | |
| | afraid | | | | |
| Middle | afraid to | E | afraid | show | don't be |
| | | | | your | |
| Middle | to show | E | to | your | be afraid |
| | | | | pearly | |
| Middle | show | E | show | pearly | afraid to |
| | your | | | whites | |
| Middle | your | E | your | | to show |
| | pearly | | | | |
| End | pearly | E | pearly | | your |
| | whites | | | | pearly |

Phrase: We fix cars, trucks and RVs.

| | | | | | | |
|---|---|---|---|---|---|---|
| Start | we fix | S | we | | | |
| Middle | fix cars | SI | fix | trucks | | Right |
| | | | | EM | | |
| Middle | trucks | SI | trucks | RVs EM | we fix | Both |
| | EM | | | | | |
| End | RVs EM | SI | RVs | | we fix | Left |

While the depicted examples use a bi-gram analysis of each phrase, it will be appreciated that any N-gram of length two or more may be used analyze the phrases in a creative. The system stores the N-gram representations of each phrase in the N-gram dataset 130. The following Table 6 includes the fields of a representative record that is stored in the N-gram dataset 130 to identify each phrase:

TABLE 6

| | | | | | |
|---|---|---|---|---|---|
| Phrase Flag | ID | Creative ID | Phrase Index | N- | Grammar |
| | | | | Gram Count | |

Where the phrase flag identifies that the record is a phrase, the ID is a unique identifier associated with the phrase, the creative ID identifies the creative with which the phrase is associated, the phrase index reflects the relative position of the phrase within the creative, the N-gram count is a count of the total number of N-grams in the phrase, and the grammar is an indication of the grammar of that phrase. The following Table 7 includes the fields of a representative record that is stored in the N-gram dataset 130 to identify each N-gram in the phrase:

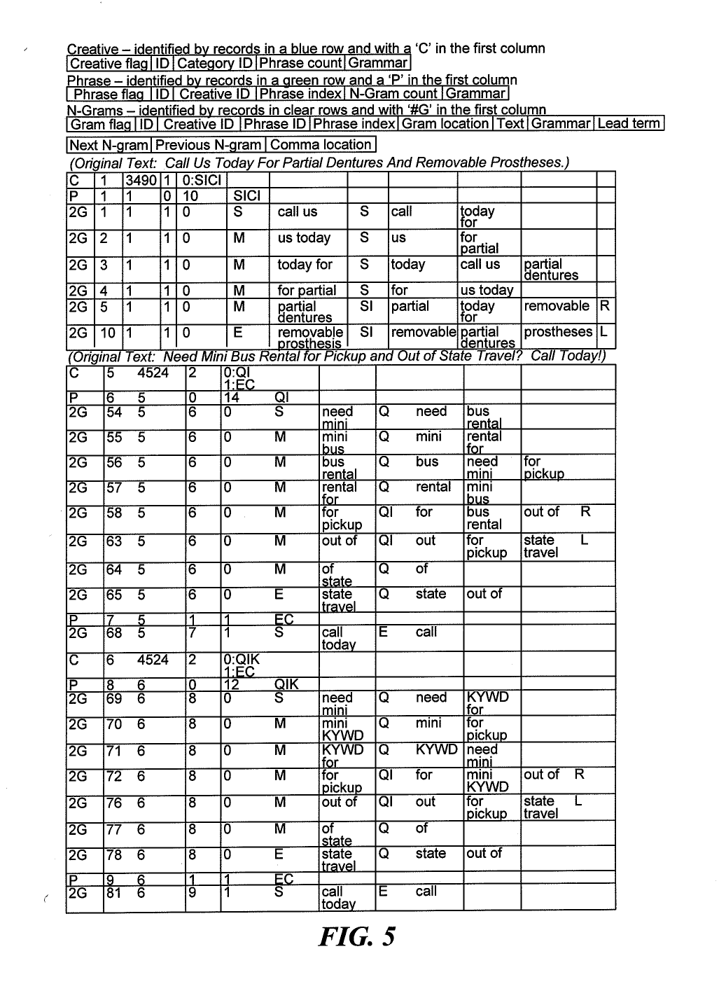

TABLE 7

| | | | | | | | | |
|---|---|---|---|---|---|---|---|---|
| Gram | ID | Crea- | Phrase | Phrase | Gram | Text | Phrase | Lead |
| Flag | | tive | ID | Index | Loca- | | Type | Term |
| | | ID | | | tion | | | |

| | | |
|---|---|---|
| Next N- | Previous N- | Comma |
| gram | gram | Location |

Where the gram flag identifies that the record is an N-gram, the ID is a unique identifier associated with the N-gram, the creative ID identifies the creative with which the N-gram is associated, the phrase ID identifies the phrase with which the N-gram is associated, the phrase index indicates the relative position of the phrase within the creative, the gram location indicates the relative position of the N-gram within the phrase, the text is the text of the N-gram, the phrase type is the type of phrase that the N-gram is associated with, the lead term is the first term in the N-gram, the next N-gram is the immediately following N-gram in the phrase, the previous N-gram is the immediately preceding N-gram in the phrase, and the comma location is the location of the comma if the N-gram is part of a list. FIG. 5 is a representative set of N-gram records, such as might be stored in the N-gram dataset 130.

Returning to FIG. 4A, at a decision block 440 the system determines whether any additional phrases remain in the creative. If additional phrases are present, the system selects another phrase at block 425 and analyzes the phrase. Blocks 425-440 thereby repeat until all phrases in the creative have been analyzed. If no additional phrases remain, then processing continues to block 445 where the system determines whether any additional creatives remain to be processed. If additional creatives remain, then processing returns to block 405 where the next historic creative is selected. Blocks 405-445 thereby repeat until all of the historic creatives have been analyzed.

Once the grammar and N-gram datasets are populated with a sufficient number of grammars and N-grams, the system is able to generate new creatives for advertisements. Returning to FIG. 2, the advertiser interface module 215 allows the system 105 to receive advertising requests from advertisers or other parties wishing to generate advertisements. The advertising requests may be manually entered by the system operator, advertisers, or other parties, or the advertising requests may be received electronically from other computer systems. Advertising requests may be received from individuals, groups, small businesses, corporations, non-profits, government entities, etc. As previously noted, the requests will typically include the product or service category for which the creatives are to be constructed, as well as other advertising campaign parameters. Requests from advertisers for creatives may be immediately executed on receipt, or the requests may be held for periodic batch processing with other requests.

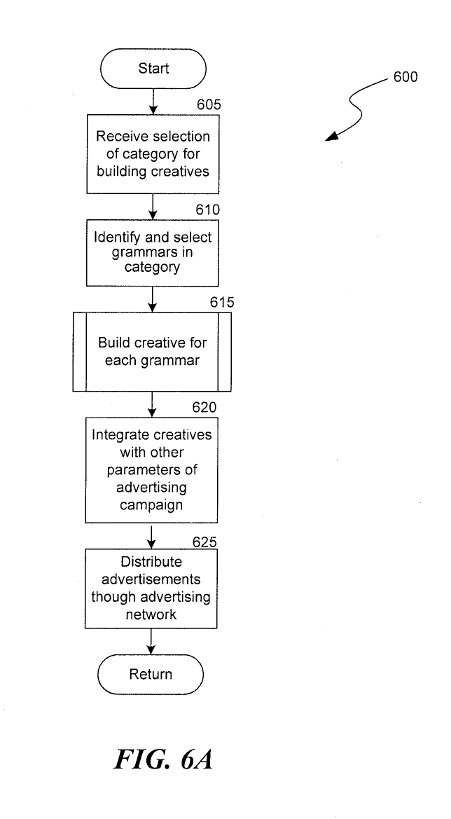

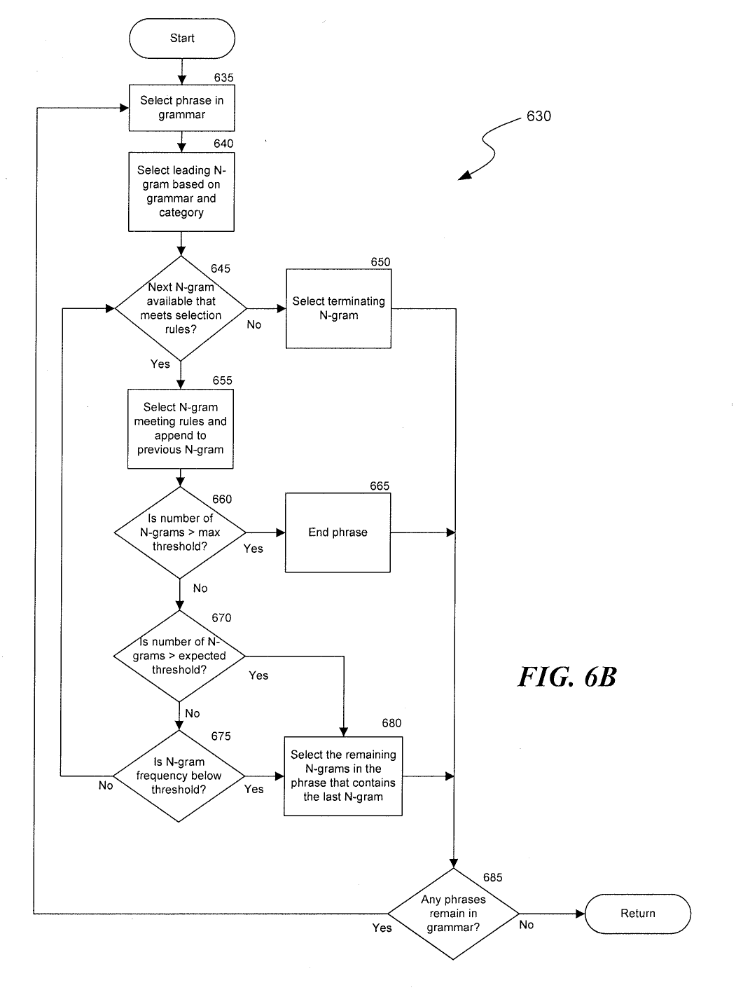

The creatives generation module 220 enables the system 105 to automatically generate creatives in response to advertising requests. FIG. 6A is a flow diagram of a process 600 executed by the creatives generation module 220 for dynamically generating creatives for advertisements. At a block 605, the system receives a selection of a category that is associated with the product or service being advertised. The received category is used to identify one or more grammars for the generation of creatives. If no category is received in an advertising request, the system may use data associated with all categories when selecting grammars or may estimate one or more categories that the desired advertising campaign is associated with.

At a block 610, the system 105 identifies and selects one or more grammars from the grammar dataset 125 that are associated with the selected category. The system may consider a variety of factors when selecting which grammars to use. For example, the system may select the grammars that are the most prevalent within the selected category on the basis that grammars that have been historically popular may be the norm within that particular category. As another example, the system may select the grammars to use based on the historical performance of the grammars in the selected category. That is, the system may select those grammars in a category that have a history of high-click through or high conversion rates. The system may also take into account the geographic, temporal, or any other characteristics of the grammar when making the selection. In some circumstances, a particular category may have a small number of grammars or little diversity in grammars. When there are only a small number of grammars to select from, the system may supplement the grammars with standard grammars used by the system across all categories, or with grammars derived from other categories that are similar to the selected category.

At a block 615, the system builds creatives for each selected grammar using N-grams from the N-gram dataset 130. FIG. 6B is a flow diagram of a process 630 that is executed by the system 105 for selecting N-grams to populate the grammar of a creative. It will be appreciated that the grammar dataset 125 and the N-gram dataset 130 inherently contain a mapping between categories, grammars, phrases, and N-grams. By selecting a particular grammar, the system is able to identify different phrases for the selected grammar and different N-grams that can populate the selected phrase (i.e., phrases and N-grams that were not associated with the selected grammar when the grammar was initially constructed). At a block 635, the system selects a phrase in the grammar to construct. At a block 640, the system selects a leading N-gram for the selected phrase. For the leading N-gram, the selected N-gram is any N-gram in the N-gram dataset having a location of “start” and meeting the category and phrase type of the selected phrase.

After selecting the leading N-gram, the system 105 then enters into a loop during which one or more N-grams are added to the leading N-gram to complete the phrase. At a decision block 645, the system determines whether any N-grams exist that may be appended to the last N-gram based on the following rules:
If the previous N-gram precedes a comma, then the system only examines N-grams that follow a comma.
If an N-gram is identified that follows the entire text of the previous N-gram (i.e., follows every word in the previous N-gram), then the N-gram is added to a list of candidate N-grams.
In no N-grams are identified that follow the entire text of the previous N-gram, then the system looks for N-grams that follow only the final term or terms of the previous N-gram. If the system identifies an N-gram that follows only the final term or terms of the previous N-gram, then the N-gram is added to a list of candidate N-grams.
   If the list of candidate N-grams is empty at decision block 645 (i.e., no N-grams satisfy the selection rules), then processing continues to block 650 where the system selects a terminating N-gram. For the terminating N-gram, the selected N-gram is any N-gram in the N-gram dataset 130 having a location of “end” and meeting the category and phrase type of the selected phrase. If the list of candidate N-grams is not empty at decision block 645, processing continues to a block 655.

At a block 655, the system 105 selects an N-gram to append to the phrase from the list of candidate N-grams. The system may select the N-gram randomly from the list of candidate N-grams, or may apply various methodologies to select the N-gram. For example, the system may select the most frequently used N-gram that is contained in the candidate list, where frequency is defined by the number of times that an N-gram appears in a category/grammar/phrase combination. The system may also select an N-gram based on the past performance of the creative from which the N-gram was derived. Other selection approaches will be apparent to one skilled in the art. Once selected, the N-gram is appended to the phrase being constructed.

Before continuing to select the next N-gram in the phrase, the system 105 performs a number of tests to ensure that the phrase is being accurately constructed. At a decision block 660, the system performs a test to see if the number of N-grams in the phrase has exceeded a maximum threshold. For example, the system may perform a check to ensure that there are not more than 20 N-grams in the phrase. If the number of N-grams in the phrase has exceeded the maximum threshold, processing continues to block 665 where the system terminates the construction of the phrase without appending a terminating N-gram. Phrases exceeding the maximum threshold without termination are typically discarded by the system since they are unlikely to generate usable phrases (i.e., the phrases are likely to include linguistic or syntactic errors). If the number of N-grams in the phrase is less than the maximum threshold, however, processing continues to a decision block 670.

At decision block 670, the system performs a test to see if the number of N-grams in the phrase has exceeded an expected number of N-grams that are likely to be found in the phrase. The likely number of N-grams is the adjusted average number of N-grams that were contained in the original creative phrases from which the model of the current phrase was derived. Alternatively, the likely number of N-grams may be the number of N-grams that were contained in the original creative phrase from which the model of the phrase was derived. If the number of N-grams in the phrase has exceeded the expected number of N-grams in the phrase, processing continues to a block 680 where the system selects the remaining N-grams in the phrase from which the last N-gram that was selected. By selecting the remaining N-grams in the phrase (i.e., by copying the end of a historic phrase onto the phrase being constructed), rather than selecting N-grams randomly, the system ensures an orderly completion of the phrase.

If the number of N-grams in the phrase has not exceeded the expected number of N-grams in the phrase, processing continues to a decision block 675 where the system performs a test to see if the diversity of a selected N-gram is too low. An N-gram's diversity is measured as the number of times it occurs in all phrases that are specified by a given category and grammar combination. The diversity reflects the popularity of the N-gram within the set of N-grams used in the selected category and grammar. If the N-gram's diversity falls below an expected threshold, processing continues to a block 680 where the system selects the remaining N-grams in the phrase from which the last N-gram that was selected. If the N-gram's diversity remains above the expected threshold, processing returns to block to decision block 645 where the system determines whether another N-gram is available to append to the phrase being constructed.

The process defined by blocks 645-680 is repeated by the system 105 until a terminating N-gram is appended to the phrase being constructed, or until one of the conditions is met which necessitates an early termination to the construction of the phrase. When the phrase construction is complete, processing continues to a decision block 685. At decision block 685, the system determines whether any phrases remain to be generated for the selected grammar. If any phrases remain to be generated, processing returns to block 635 where the next phrase in the grammar is selected and the phrase constructed with N-grams. If no phrases remain in the grammar, generation of the creative is complete.

Returning to FIG. 6A, after creatives have been generated for all of the selected grammars, processing continues to a block 620. At block 620, the system integrates the creatives with any other parameters of the advertising campaign. For example, the system associates the creatives with the budget of the campaign, the time during which the campaign should run, and various rules that specify the conditions under which the advertisements with generated creatives are to be distributed. At a block 625, the system distributes the generated advertising creatives through one or more advertising networks in accordance with the advertising parameters. Prior to distributing the advertising creatives, a system operator may opt to have the generated creatives manually reviewed by editors to ensure that the creatives maintain sense and meaning. It will be appreciated that the editorial review of automatically-generated creatives is a significantly less time-consuming process than requiring that the creatives be manually created from scratch.

Returning to FIG. 2A, in some embodiments the system 105 includes a performance monitoring module 225. The performance monitoring module 225 receives data from the advertising distribution network that characterizes the performance of the generated creatives. The system may track those creatives that perform highly, meaning that they perform statistically better than other creatives within their respective category. The system may also track those creatives that perform poorly, meaning that they perform statistically worse than other creatives within their respective category. The performance of the creatives may be noted by the system in the grammar dataset 125, and used as a factor by the creatives generation module 220 when selecting grammars for the generation of future creatives.

By automatically generating creatives for advertisements, the system 105 greatly reduces the amount of manual resources that are required to generate and launch advertising campaigns through one or more distribution networks. Moreover, the system improves the performance of creatives by basing the automatically-generated creatives at least in part on creatives that have been successful or frequently used in generating advertising traffic from consumers in the past.

From the foregoing, it will be appreciated that specific embodiments of the invention have been described herein for purposes of illustration, but that various modifications may be made without deviating from the invention. For example, the tables depicted herein are designed to make them more comprehensible by a human reader. Those skilled in the art will appreciate that the actual data structure(s) used by the system to store information may differ from the tables shown, in that they, for example, may be organized in a different manner, may contain more or less information than shown, may be compressed and/or encrypted, and may be optimized in a variety of ways. Those skilled in the art will further appreciate that the depicted flow diagrams may be altered in a variety of ways. The order of the steps in the flow diagrams may be rearranged, steps may be performed in parallel, steps may be omitted, or other steps may be included. Accordingly, the invention is not limited except as by the appended claims.

I claim:

1. A computer-implemented method of generating creatives for advertisements, the computer-implemented method comprising:
identifying a plurality of creatives associated with advertisements that have previously been distributed to consumers via online advertising distribution networks;
for each identified creative:
characterizing a grammatical structure of the creative;
characterizing a relationship between adjacent words in the creative; and
storing the characterization of the grammatical structure of the creative and the characterization of the adjacent words in the creative;
receiving a request to generate a new creative; and
in response to the received request, selecting a grammatical structure of a creative from the stored grammatical structures and automatically populating the selected grammatical structure using words selected from the stored characterization of adjacent words to generate the new creative.

2. The computer-implemented method of claim 1, wherein the adjacent words are characterized by dividing the words of the creative into N-grams and characterizing adjacent N-grams.

3. The computer-implemented method of claim 2, wherein the N-grams are bi-grams or tri-grams.

4. The computer-implemented method of claim 1, wherein the plurality of creatives associated with advertisements that have previously been distributed are associated with a common category.

5. The computer-implemented method of claim 4, further comprising storing the common category in association with the characterization of the grammatical structure and the characterization of the adjacent words.

6. The computer-implemented method of claim 5, wherein the new creative is associated with the common category.

7. The computer-implemented method of claim 1, further comprising, prior to characterizing the relationship between adjacent words, replacing characters, words, or phrases in the creative with one or more tokens.

8. The computer-implemented method of claim 1, wherein the characterization of adjacent words includes storing the adjacent words as N-grams and automatically populating the selected grammatical structure comprises:
selecting an N-gram; and
selecting one or more additional N-grams that satisfy a selection rule and appending each additional selected N-gram to preceding selected N-grams until a termination condition is detected.

9. The computer-implemented method of claim 8, wherein the termination condition is the number of N-grams in the new creative exceeding a maximum threshold.

10. The computer-implemented method of claim 8, wherein the termination condition is the number of N-grams in the new creative exceeding an expected threshold.

11. The computer-implemented method of claim 8, wherein the termination condition is the frequency of an appended N-gram failing to exceed a threshold frequency.

12. The computer-implemented method of claim 8, wherein the termination condition is a lack of an additional N-gram that meets the selection rule.

13. The computer-implemented method of claim 1, wherein characterizing a relationship between adjacent words in the creative comprises:
characterizing a location of the adjacent words within the creative;
characterizing a next set of adjacent words in the creative; and
characterizing a previous set of adjacent words in the creative.

14. A computer-implemented method of creating a data set that is used to automatically generate creatives for advertisements, the computer-implemented method comprising:
identifying a plurality of creatives associated with advertisements in a particular business category that have previously been distributed to consumers via advertising distribution networks;
characterizing each of the plurality of creatives by:
characterizing a grammatical structure of a creative;
characterizing a relationship between N-grams in the creative; and
storing the characterization of the grammatical structure of the creative, the characterization of the relationship between N-grams in the creative, and an identification of the business category associated with the creative, such that the stored characterizations may be used to automatically generate new creatives for the associated business category.

15. The computer-implemented method of claim 14, wherein the N-grams are bi-grams or tri-grams.

16. The computer-implemented method of claim 14, further comprising, prior to characterizing the relationship between N-grams, replacing characters, words, or phrases in the creative with one or more tokens.

17. The computer-implemented method of claim 14, further comprising cleaning the plurality of creatives to remove elements prior to characterizing each creative.

18. The computer-implemented method of claim 14, wherein characterizing a relationship between N-grams in the creative comprises, for each N-gram:
characterizing a location of the N-gram within the creative;
characterizing a next N-gram in the creative; and
characterizing a previous N-gram in the creative.

19. The computer-implemented method of claim 14, wherein the creative is a single phrase and characterizing the grammatical structure of the creative further comprises characterizing the single phrase.

20. The computer-implemented method of claim 14, wherein the creative includes two or more phrases and characterizing the grammatical structure of the creative further comprises characterizing the two or more phrases.

21. The computer-implemented method of claim 20, further comprising storing the characterization of the two or more phrases in association with the stored characterization of the grammatical structure of the creative.

22. The computer-implemented method of claim 14, wherein the plurality of creatives associated with advertisements in a particular business category are identified based on the past performance of the creatives.

23. A computer-implemented method of generating creatives for advertisements, the computer-implemented method comprising:
receiving a request to generate a new creative associated with an advertising category; and
in response to the received request, selecting a grammatical structure of a creative from a set of grammatical structures that have previously been utilized in advertisements within the advertising category that were distributed to consumers via an advertising network; and
automatically selecting two or more N-grams from a stored characterization of N-grams in order to populate the selected grammatical structure and generate the new creative, wherein the N-grams were previously utilized in advertisements within the advertising category that were distributed to consumers.

24. The computer-implemented method of claim 23, wherein selecting two or more N-grams from a stored characterization of N-grams comprises:
selecting an N-gram; and
selecting one or more additional N-grams that satisfy a selection rule and appending each additional selected N-gram to preceding selected N-grams until a termination condition is detected.

25. The computer-implemented method of claim 24, wherein the termination condition is the number of N-grams in the new creative exceeding a maximum threshold.

26. The computer-implemented method of claim 24, wherein the termination condition is the number of N-grams in the new creative exceeding an expected threshold.

27. The computer-implemented method of claim 24, wherein the termination condition is the frequency of an appended N-gram failing to exceed a threshold frequency.

28. The computer-implemented method of claim 24, wherein the termination condition is a lack of an additional N-gram that meets the selection rule.

29. The computer-implemented method of claim 23, further comprising distributing the generated new creative through an advertising network.

30. A computer-readable storage medium containing a data set that is used to automatically generate creatives for advertisements, the computer-readable storage medium comprising:
a characterization of a grammatical structure of a creative, the creative derived from a plurality of creatives associated with advertisements in a particular business category that have previously been distributed to consumers via advertising distribution networks;
a characterization of a relationship between N-grams in the selected creative; and
an identification of the business category associated with the selected creative, the stored characterizations of the grammatical structure and the relationship between N-grams allowing the automatic generation of new creatives for the associated business category.

31. The computer-readable medium of claim 30, wherein the N-grams are bi-grams or tri-grams.

32. The computer-readable medium of claim 30, wherein the N-grams include tokens replacing characters, words, or phrases in the creative.

33. The computer-readable medium of claim 30, wherein the characterization of the relationship between N-grams in the creative comprises, for each N-gram:
a location of the N-gram within the creative;
a next N-gram in the creative; and
a previous N-gram in the creative.

34. The computer-readable medium of claim 30, wherein the selected creative is a single phrase and the characterization of the grammatical structure of the selected creative further comprises a characterization of the single phrase.

35. The computer-readable medium of claim 30, wherein the selected creative includes two or more phrases and the characterization of the grammatical structure of the selected creative further comprises a characterization of the two or more phrases.
